(19) United States
(12) Patent Application Publication
(10) Pub. No.: US 2025/0158691 A1
(43) Pub. Date: May 15, 2025

(54) UE OPERATION FOR MULTI-TRP SYSTEM FOR WIRELESS NETWORKS

(71) Applicant: Nokia Technologies Oy, Espoo (FI)

(72) Inventors: Timo KOSKELA, Oulu (FI); Lars DALSGAARD, Oulu (FI); Daejung YOON, Nozay (FR)

(21) Appl. No.: 18/726,343

(22) PCT Filed: Jan. 6, 2022
(86) PCT No.: PCT/US2022/011486

§ 371 Date: Jul. 2, 2024

(51) Int. Cl. H04B 7/06; H04L 27/26; H04W 72/1273

(52) U.S. Cl. CPC H04B 7/06964; H04L 27/261; H04W 72/1273

(57) ABSTRACT

An method includes determining, by a user device, a configuration for a plurality of beam failure detection reference signal (BFD-RS) sets, and a candidate beam set associated with each of the plurality of (BFD-RS) sets; determining, by the user device, a beam failure status of the plurality of (BFD-RS) sets, including determining a beam failure for at least one of the (BFD-RS) sets; adjusting at least one of the following based on the beam failure status of the plurality of (BFD-RS) sets: a candidate beam evaluation period to evaluate candidate beams of an associated candidate beam set after a beam failure of one of the (BFD-RS) sets; a beam failure detection evaluation period for the user device to detect a failure of one of the (BFD-RS) sets; and scheduling restrictions that restrict or not restrict occasions in which the user device is required to monitor a downlink control channel.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include determining, by a user device within a wireless network, a configuration for a plurality of beam failure detection reference signal sets, and a candidate beam set associated with each of the plurality of beam failure detection reference signal sets; determining, by the user device, a beam failure status of the plurality of beam failure detection reference signal sets, including determining a beam failure for at least one of the beam failure detection reference signal sets; adjusting, by the user device, at least one of the following based on the beam failure status of the plurality of beam failure detection reference signal sets: a candidate beam evaluation period for the user device to evaluate candidate beams of an associated candidate beam set after a beam failure of one of the beam failure detection reference signal sets; a beam failure detection evaluation period for the user device to detect a failure of one of the beam failure detection reference signal sets; and scheduling restrictions that restrict or not restrict occasions in which the user device is required to monitor a downlink control channel.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating a multi-TRP system according to an example embodiment.

FIG. 3 is a diagram illustrating operation of beam failure recovery in a multi-TRP system according to an example embodiment.

FIG. 4 is a diagram illustrating operation of beam failure recovery in a multi-TRP system that includes a primary (or master) TRP according to an example embodiment.

FIG. 5 is a flow chart illustrating operation of a UE according to an example embodiment.

FIG. 6 is a block diagram of a node or wireless station (e.g., AP, BS, gNB, TRP, network node, user device, UE, or other wireless node) according to an example embodiment.

### DETAILED DESCRIPTION

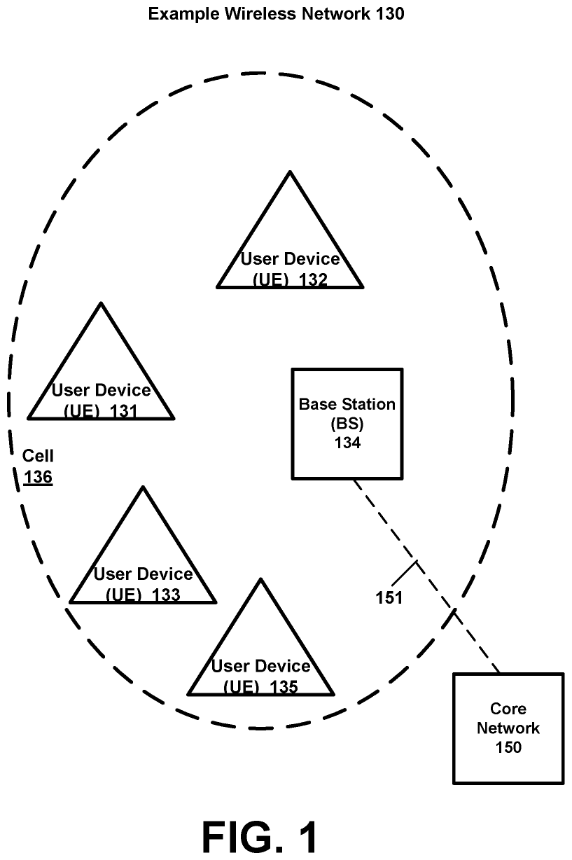

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a next generation Node B (gNB), or network node. The terms user device and user equipment (UE) may be used interchangeably. A BS may also be referred to as a RAN (radio access network) or NG-RAN (next generation radio access network) node. At least part of the functionalities of a BS (e.g., AP, gNB, eNB, RAN node) may also be carried out by one or more network nodes, servers or hosts, such as a centralized unit (CU) and a distributed unit (DU) in a split RAN architecture, which may be operably coupled to a remote transceiver, such as a remote radio head (RRH). BS 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

According to an illustrative example, a BS (e.g., AP, eNB, gNB, RAN node) may be part of a mobile telecommunication system. A RAN may include one or more RAN nodes (e.g., AP, BSs, eNBs, gNBs) that implement a radio access technology, e.g., to allow one or more UEs to have access to a network or core network. Thus, the RAN nodes reside between one or more user devices or UEs and a core network. According to an example embodiment, each RAN node may provide one or more wireless communication services for one or more UEs or user devices, e.g., to allow the UEs to have wireless access to a network, via the RAN node. Each RAN node may perform or provide wireless communication services, e.g., such as allowing UEs or user devices to establish a wireless connection to the RAN node, and sending data to and/or receiving data from one or more of the UEs. For example, after establishing a connection to a UE, a RAN node may forward data to the UE that is received from a network or the core network, and/or forward data received from the UE to the network or core network. RAN nodes may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node may perform.

A user device (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, a wearable device, as examples, or any other wireless device. It should be appreciated that a user device may also be (or may include) a nearly exclusive uplink only device, of which an example is a camera or video camera loading images or video clips to a network.

Core network 150 may include a mobility management entity (MME) or an access and mobility management function (AMF), which may control access to the network, and handle or assist with mobility/handover of user devices between BSs, one or more gateways that may forward data between the BSs and a packet data network or the Internet, and other control nodes, functions or blocks.

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to a eMBB UE (or an eMBB application running on a UE).

The various example embodiments may be applied to a wide variety of wireless technologies or wireless networks, such as LTE, LTE-A, 5G/New Radio (NR), or any other wireless network or wireless technology operating on cmWave and/or mmWave bands, and to a wide variety of communication services, such as IoT, MTC, eMTC, eMBB, URLLC, etc. These example networks, technologies or data service types are provided only as illustrative examples.

A UE may be configured by a gNB (or other network node) to perform different measurements and measurement reporting to the network (or gNB(s)). A configuration of a UE to perform reference signal (or beam) measurement (e.g., such as CSI-RS measurement for different beams) and reporting may be performed by a gNB sending a report configuration (e.g., such as a CSI-Report-Config) to the UE. A report configuration, for example, may indicate downlink resource(s) on which measurements should be performed (e.g., CSI-RS reference signals/SSBs, or beams), specific quantities or parameters to be measured, and how the reporting is to be performed, such as when the reporting is done, etc.

A UE may measure a signal parameter(s) (e.g., such as a reference signal received power (RSRP)) of each of a plurality of downlink reference signals (e.g., such as synchronization signal block/SSB signals, or channel state information (CSI)-reference signals (CSI-RS)) received by the UE from the gNB/network node (or BS), where each reference signal may be transmitted by the gNB via a different gNB transmit beam (or via a different downlink DL reference signal). The UE may determine the strongest beams or reference signals (e.g., having a highest RSRP), and then may send a measurement report to the gNB that may identify the strongest N DL reference signals (or beams), and the RSRP (or other measured signal parameter) of these N beams, for example. The gNB may use this measurement report to determine what beam to use to communicate with the UE, for example.

According to an example embodiment, a PDCCH (physical downlink control channel) may be transmitted using 1, 2, 4, 8 or 16 contiguous control-channel elements (CCEs), where the number of CCEs may be referred to as the aggregation level (or CCE aggregation level). According to an example embodiment, a CCE is a building block of a PDCCH, where a CCE may be a smallest set of resources that can be used for a PDCCH. For example, a CCE may be a unit upon which search spaces for blind decoding may be defined. Thus, each PDCCH may include one or more CCEs, depending on the aggregation level. According to an example embodiment, a CCE may include 6 resource element groups (REGs), each of which may include one resource block in an OFDM symbol.

A search space may include a set of candidate PDCCHs (candidate downlink control channels) formed by CCEs at given aggregation level(s), which the UE is supposed to attempt to decode. A UE may have multiple search spaces for different purposes (such as different common search spaces, and user-specific search spaces). A search space may include one or more control resource sets (CORESETs). A CORESET may be (or may include) the time-frequency resources upon which a PDCCH(s) is transmitted. There can be multiple search spaces using a same control resource set (CORESET), and there can be multiple CORESETs configured for a UE. Also, a control resource set (CORESET) may be (or may include) time-frequency resources in which the UE tries to decode candidate PDCCHs using one or more search spaces.

At a configured PDCCH monitoring occasion (e.g., time(s) or locations within a slot where a PDCCH may be transmitted) for a search space, UEs will attempt to decode the candidate PDCCHs for that search space, for one or more DCI formats. PDCCH monitoring may include, for example, demodulating a received signal, decoding the demodulated PDCCH or DCI, e.g., to detect that the DCI is (or is not) assigned to or intended for the receiving UE. Decoding of Downlink Control Information (DCI) may use blind decoding where the UE may perform a number of decoding attempts on a number of Physical Downlink Control Channel (PDCCH) candidates for a number of defined DCI formats that are being monitored by the UE.

Release 16 of NR provided support for single cell downlink multi-transmission reception points (multi-TRP) (or multiple transmission points), which provides the possibility of downlink data to be transmitted via PDSCH (physical downlink shared channel) simultaneously from two different transmission points (TRPs), which may be separated geographically, but are provided within the same cell (e.g., transmissions of downlink data from two different radio heads or other network nodes to a UE within a cell).

For single cell, single DCI-based multi-TRP transmission, a single DCI schedules a single PDSCH, where multiple ways of transmitting PDSCH can be supported. In single DCI-based multi-TRP SDM (spatial division multiplexing) transmission scheme, multi-layer PDSCH is scheduled by a single DCI, where different PDSCH layers may be transmitted from different TRPs. Although, the multiple TRPs will transmit a single transport block. Similarly, there are several other single DCI-based multi-TRP transmission schemes following FDM (frequency division multiplexing) and TDM (time division multiplexing) approaches of multi-TRP transmission.

For single cell, multi-DCI multi-TRP transmission, there is one PDSCH (physical downlink shared channel, or downlink data channel) with an associated transport block transmitted from each TRP, and with each PDSCH being scheduled by separate DCIs carried by separate PDCCH (physical downlink control channels). In some cases, either single-DCI based TRP transmission or multi-DCI based TRP transmission may be used or performed.

Also, by adjusting a weight (e.g., amplitude and/or phase) of each antenna element of an antenna panel or antenna system, a node (e.g., network node and/or UE) may provide directivity in which transmission power may be directed in a specific direction via beamforming. Beamforming may be used also to provide receiver-side directivity. Because each beam may typically cover only a limited area or direction, multiple beams are typically required. Example beams may include synchronization signal block reference signal (SSB-RS) beams, and channel state information reference signal (CSI-RS) beams, where each reference signal is associated with a different beam, as it may point in a different direction. A gNB or network node may utilize multiple beams to cover the entire service area, and one or a subset of those beams may be associated with a UE (e.g., may point in a direction towards the UE and/or may be a strongest beam for communication with the UE). However, due to UE movement and/or other conditions, the best beam for a UE may change over time, and may result in beam misalignment. A beam failure may occur in which a beam failure instance has been detected a threshold number of times before a timer expires, where a beam failure instance may be a reference signal receive power of a reference signal for the beam that is less than a threshold. Thus, beam recovery procedures may be used. For example, a beam recovery procedure may be used by a UE that may include: 1) a UE detecting beam failure (beam failure detection); 2) evaluating candidate beams to select a new beam, or a strongest beam (candidate beam evaluation); and 3) sending a report (e.g., a beam failure report) to a TRP or network node, e.g., indicating that beam failure was detected, indicating the selected new beam, and/or indicating that a new beam meeting a threshold signal condition was not found).

For beam failure detection, at least in some cases, a gNB or TRP (or network node) may configure a UE with (UE may receive information indicating) beam failure detection reference signals (BFD-RS). In an illustrative beam detection procedure, the UE may determine or detect a beam failure when a number of beam failure instances (e.g., detected by the UE) reaches a threshold before a timer expires.

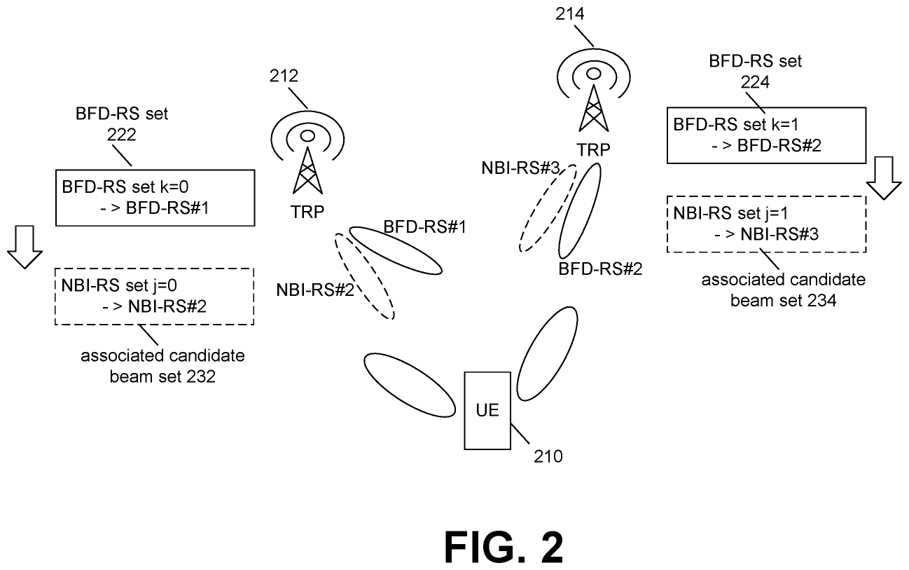

FIG. 2 is a diagram illustrating a multi-TRP system according to an example embodiment. A UE 210 may be in communication with both TRP 212 and TRP 214 (e.g., UE 210 may have a connection with each of TRP 212 and TRP 214). In an example embodiment, one of the TRPs may be a master or primary TRP, while the other TRP(s) are non-primary TRPs. A primary (e.g., master) TRP may control one or more aspects of a multi-TRP communication session with a UE. For example, UE 210 may first establish a connection with a primary (or master) TRP, before establishing a connection(s) with non-primary TRP(s). Also, the primary TRP may control the addition and/or configuring of the non-primary TRP, in some example embodiments. Therefore, according to an example embodiment, the link or connection between the UE and the primary TRP may be considered more important (or more critical to maintain) than the link or connection between the UE and non-primary TRP. In some example embodiments, a primary TRP may refer to one or more CORESETs configured under a same higher layer index such as #0 or #1. This higher layer index may be referred as CORESETPoolIndex. CORESET(s) under the same pool index value (e.g., 0 or 1) may be considered to be grouped, e.g., in terms of beam failure detection, i.e., there may one set of beam failure detection reference signals, BFD-RS, (comprising of one or more reference signals) associated with a specific pool index. In some examples, the primary TRP may refer to a BFD-RS set with specific index such as ‘0’ (or 1). This may be network configurable or pre-configured/pre-agreed.

UE 210 UE may be configured with one or more beam failure detection reference signal (BFD-RS) sets, where each BFD-RS set may include one or more BFD-RS signals, which may be used by the UE to detect a beam failure. In an example embodiment, UE 210 may be configured with up to two (for example) BFD-RS sets per DL (downlink) bandwidth part (BFD-RS set k=0,1) (2 sets of BFD-RSs) and associated or respective candidate beam sets (NBI-RS j=0,1), where a candidate beam set is associated with each BFD-RS set. The BFD-RS set configured for the primary (e.g., master) TRP may be referred to as the primary BFD-RS set, while the BFD-RS set configured for a non-primary (e.g., a secondary) TRP may be referred to as a non-primary BFD-RS set. For example, for UE 210, a BFD-RS set 222, and an associated candidate beam set 232, may be configured for TRP 212. And, a BFD-RS set 224, and an associated candidate beam set 234, may be configured for TRP 214. According to an example embodiment, a first specific set (e.g., BFD-RS set) index number (e.g., index=0) may be used to indicate a BFD-RS set and/or associated candidate beam set configured for a primary TRP, and a second specific set index (e.g., index=1) may be used to indicate a BFD-RS set and/or associated candidate beam set configured for a non-primary TRP.

BFD-RS(s) (within a BFD-RS set) are reference signals the UE monitors for (e.g., measures a signal parameter, such as RSRP of the reference signal, to detect) beam failure. Beam failure may be detected, for example, when the UE detects a number of beam failure instances (where each beam failure instance may be a detected RSRP less than a threshold) for a beam(s) (of the BFD-RS set) that has reached or exceeded a threshold number of instances within a period of time. After a beam failure of a BFD-RS set has been detected by a UE (or where the UE has been notified of the beam failure by another node, such as the UE notified by the TRP associated with the non-failed BFD-RS set), the UE 210 may be required to evaluate beams (reference signals) of the associated candidate beam set to select a beam (reference signal). Each candidate beam set (232, 234) may include a set of reference signals (each provided via a different beam), such as a set of new beam identification reference signals (NBI-RSs), or other reference signals that may be evaluated (measured) by the UE to identify or select a new (best) beam, in the event of beam failure.

The BFD-RS set k_i (BFD-RS set 222) and NBI-RS set j_i (candidate beam set 232) may be one to one mapped (associated with each other). Similarly, BFD-RS set 224 is associated with candidate beam set 234. When a beam failure is detected for a BFD-RS set, the UE may typically search (or, may be required to search) candidate beams from the associated candidate beam set to find a suitable beam (e.g., a best beam, or a beam having a RSRP greater than a threshold, or other signal criteria). As an example, when the BFD-RS set k=0 (BFD-RS 222) fails (e.g., beam failure detected by UE), UE 210 may search (or limits it candidate search to) candidate beams (e.g., measure beam/NBI-RS RSRP) from the associated candidate beam set NBI-RS set j=0 (candidate beam set 232).

In a multi-TRP communication session, there may be several functions or operations the UE may perform (or may need to perform), at various times, for one or both BFD-RS sets (or TRPs), including, for example:
1) UE monitoring a downlink control channel (e.g., PDCCH). As noted, at configured PDCCH monitoring occasions (e.g., time(s) or locations within a slot where a PDCCH may be transmitted) for a search space, UE 210 may attempt to decode the candidate PDCCHs for that search space, for one or more DCI formats. PDCCH monitoring may include, for example, demodulating a received signal, decoding the demodulated PDCCH or DCI, e.g., to detect that the DCI is (or is not) assigned to or intended for the receiving UE.
2) the UE performing beam failure detection evaluation, where the UE may measure a signal parameter(s) (e.g., RSRP (reference signal received power), BLER (block error rate), SINR (signal to interference plus noise ratio) of beam(s) of a BFD-RS set, to determine whether a beam failure has occurred for the BFD-RS set. A specific period of time, which may be referred to as a beam failure detection evaluation period, may be allocated or configured for the UE to perform beam failure detection evaluation. And,
3) UE performing candidate beam evaluation. After a beam failure of one of the BFD-RS sets has occurred or been detected, the UE may evaluate candidate beams of an associated candidate beam set. The UE may evaluate candidate beams for a candidate beam evaluation period. For example, at (or before) the end of the candidate beam evaluation period, the UE may send a report (e.g., beam failure report) indicating that a beam failure occurred, and identifying the selected candidate beam, or indicating that a candidate beam was not found/selected that satisfies a threshold signal criteria (e.g., a beam having a RSRP greater than a threshold value).

In any of the example embodiments herein, UE may, for example, determine an association of downlink/uplink scheduling with the specific BFD-RS set through the grouping or pooling of CORESETs under a same index value, e.g., there may be a one-to-one mapping (or association) of CORESETpoolIndex and BFD-RS set index. As an example, the CORESET #1 may be configured with CORESETPoolIndex #0 and CORESET #2 with CORESETPoolIndex #1 (or other parameter used for grouping CORESETs to different groups). If downlink control information (PDCCH) is monitored on CORESET #1 using downlink RS #1 as source signal/reference for PDCCH reception, the RS #1 may be included into the BFD-RS set #0. Thus, UE may be able to determine whether it is being scheduled on at least on CORESET associated with specific BFD-RS set and determine its failure status. In some examples the failure (or non-failure) of specific BFD-RS set may be determined based on whether the candidate beam evaluation has been requested or not (e.g. MAC layer may request L1 or other layer to perform candidate beam search/evaluation). As an example, if candidate beam evaluation (of set of candidate beams associated with specific BFD-RS) has been requested/started, it may be assumed that the associated BFD-RS set has failed or considered to be failed. This information may be further used for, e.g., determining whether (or not) to apply scheduling restrictions or scaling for evaluation periods as described herein. In other words, UE may determine the failure of a specific BFD-RS set based on the request to evaluate candidate beams for the associated BFD-RS set. In one example, a request to evaluate candidate beams in a candidate beam set associated with a beam failure detection beam reference signal set indicates a beam failure for the beam failure detection beam reference signal set.

As can be seen from FIG. 2, a multi-TRP communication session may involve a UE transmitting and/or receiving signals via different beams (different directions), since the TRPs (e.g., TRP 212 and TRP 214) may generally be located in different physical locations. Also, for example, in the most common situation where the UE has a single antenna panel, the UE may be able to form only one beam at a time, and thus, the UE may be able to form a beam to perform only one of the above three operations at a time, for example. Thus, these operations may need to be multiplexed in time. Situations may arise in which the UE may be requested to perform (or may need to perform) one of these operations 1)-3) above (monitoring a downlink control channel, beam failure detection evaluation and/or candidate beam evaluation) for one TRP or BFD-RS, and perform a different of these operations for a different TRP or BFD-RS. For example, when a beam failure of one of the BFD-RS sets has occurred, the UE may need to perform candidate beam evaluation for the failed BFD-RS set, while continuing to perform beam failure detection evaluation and monitoring a downlink control channel (e.g., PDCCH) of the non-failed BFD-RS set (the control channels associated with the non-failed BFD-RS set/TRP). Depending on the situation, some of these operations may be considered more important than the others. As an illustrative example, as noted above, in some cases, one TRP may be a primary TRP (BFD-RS set), while another TRP (BFD-RS set) may be a non-primary TRP (BFD-RS set). Therefore, for example, the UE connection to the primary TRP may be considered more important or more critical than the UE connection to the non-primary TRP. Thus, as an illustrative example, it may be more important or urgent for the UE to re-establish the primary TPR (monitored using RS in primary/associated BFD-RS set) by performing candidate beam evaluation of the candidate beam set associated with the primary BFD-RS set after a failure of the BFD-RS, than to monitor the downlink control channel and/or perform beam failure detection evaluation for the non-primary TRP monitored using associated BFD-RS set (which in this example has not failed).

Thus, according to an example embodiment, the UE (and/or network node/TRP) may adjust one or more parameters associated with these operations 1)-3) (downlink control channel monitoring, beam failure detection, candidate beam evaluation) which may provide a technique for the UE to prioritize, and/or to adjust or apply more or less resources, for one or more of these operations 1)-3) listed above (monitoring a downlink control channel, beam failure detection evaluation and/or candidate beam evaluation), depending on the situation. Thus, one or more of the following may be performed by a UE, e.g., based on a beam failure status of the BFD-RS sets:
1) Adjusting scheduling restrictions that may restrict (reduce or limit) or not restrict occasions in which the user device UE (user device) is required to monitor a downlink control channel (e.g., PDCCH). Thus, applying scheduling restrictions to restrict occasions where the UE should monitor a downlink control channel (e.g., in the case where there is a conflict between operations) may free up (or make available) resources (e.g., time, frequency and beam resources) of the UE to perform other operation that may be considered more important or more urgent, in some cases, and that should be performed at that time that the UE would have been required to monitor the downlink control channel (in the absence of scheduling restrictions). Thus, scheduling restrictions may be applied, or not applied, depending on the situation. Applying scheduling restrictions for downlink reception and/or uplink transmission associated with the first BFD-RS set may allow the UE to perform other (e.g., more important or more urgent) activities or operations (during a conflict or collision of these operations or activities), such as performing candidate beam evaluation for a failed BFD-RS set, as an example (instead of monitoring a downlink control channel associated with the non-failed BFD-RS set in the absence of scheduling restrictions). Thus, the scheduling restrictions provide a technique to allow the UE to prioritize other operations (e.g., performing candidate beam evaluation of a failed BFD-RS) over monitoring a downlink control channel associated with a non-failed BFD-RS, in the event these operations conflict or collide in time. Thus, for example, adjusting scheduling restrictions may include, adjusting of scheduling restrictions that may restrict or not restrict occasions in which the UE is required to monitor a downlink control channel (e.g., PDCCH) associated with a non-failed BFD-RS set in order for the UE to prioritize or adjust prioritization of, in case of a conflict, candidate beam evaluation to evaluate candidate beams associated with a failed BFD-RS set over monitoring a downlink control channel associated with a non-failed BFD-RS set.
2) Adjusting a beam failure detection evaluation period for the user device (UE) to detect a failure of one of the BFD-RS sets. For example, by adjusting (e.g. scaling) a beam failure detection evaluation period for a non-failed BFD-RS, this may free up resources (time, frequency and/or beam resources) that the UE may use to perform other operations, such as to perform candidate beam evaluation of a failed BFD-RS. Or, for example, the beam failure detection evaluation period may be increased to allow the UE more time to complete the beam failure detection evaluation, where the UE may spend a portion of that period performing other operations or activities that may be considered to be more urgent or important. For example, a scaling factor may be adjusted to cause the beam failure detection evaluation period to be adjusted.
3) Adjusting a candidate beam evaluation period for the UE to evaluate candidate beams of an associated candidate beam set after a beam failure of one of the beam failure detection reference signal sets. For example, in a case where a beam failure was detected for a primary BFD-RS set, a standard (or a short) candidate beam evaluation period (e.g., scaling factor=1, or no scaling applied to candidate beam evaluation period) may be used by the UE, to cause the UE to perform/complete the candidate beam evaluation quickly for the failed primary BFD-RS set (e.g., the deadline to send a beam failure report to network node or TRP with selected candidate beam, or an indication that no beam was found, is not extended), since it may be considered very important or urgent for the UE to find a new candidate beam and re-establish the link or connection with the primary TRP as soon as possible. On the other hand, in the case where a beam failure was detected for a non-primary BFD-RS set, an increased or longer candidate beam evaluation period may be applied (e.g., a scaling factor greater than 1, e.g., 1.5 or 2.0, applied to increase the candidate beam evaluation period) for the non-failed BFD-RS set, in order to allow the UE to extend the deadline for sending a BFR report to the network node or TRP for the non-primary BFD-RS set (non-primary TRP), which may allow the UE to use a portion of that candidate beam evaluation period (which has been extended) to perform operations for the more critical primary BFD-RS set (such as monitoring downlink control channel and/or performing beam failure detection evaluation for the primary BFD-RS set, which may be considered more important, or which should not be stopped/ceased).

In one example embodiment, in case of overlapping/conflicting occasions (e.g. the RSs are transmitted on the same time instance/same symbol and UE has to choose which RS to measure/detect)) occur for candidate beam evaluation for the primary BFD-RS set and beam failure detection of non-primary BFD-RS set, UE may prioritize the candidate beam evaluation. In one example embodiment, in case of overlapping/conflicting occasions (e.g. the RSs/channels are transmitted on the same time instance/same symbol and UE has to choose which RS/channel to measure/receive)) occur for candidate beam evaluation for the primary BFD-RS set and PDCCH reception of non-primary BFD-RS set, UE may prioritize the candidate beam evaluation.

The adjusting scheduling restrictions, adjusting a beam failure detection evaluation period, and/or adjusting a candidate beam evaluation period for one or more BFD-RS sets may be performed based on a beam failure status (e.g., failed, or not failed) of the plurality of BFD-RS sets. Beam failure status may include one or more of the following, as examples: only one of the plurality of beam failure detection reference signal (BFD-RS) sets configured for the UE has failed; at least one of the plurality of BFD-RS sets, but fewer than all of the plurality of BFD-RS sets configured for the UE, has failed; all of the plurality of BFD-RS sets configured for the UE have failed; a primary BFD-RS set configured for the UE has failed, but a non-primary BFD-RS set configured for the UE has not failed; a non-primary BFD-RS set configured for the UE has failed, but a primary BFD-RS set configured for the UE has not failed.

According to an example embodiment, in case only 1 TRP (only one BFD-RS set) fails, the UE connection with the other TRP is still available for communication, and hence the other TRP is still capable of scheduling. In this situation, it may not be beneficial to apply scheduling restrictions, e.g., if both BFD-RS sets are equally important. On the other hand, in some cases, failed TRPs (BFD-RS sets) may not be equally important e.g., typically common channels (uplink control information (UCI) and downlink control information (DCI) are scheduled from CORESETs having specific CORESETpoolIndex (e.g., poolindex=0). It may also be the CORESETpoolindex that contains CORESET #0 or CORESET configured with searchspacezero. CORESETpoolindex is a higher layer configured (poolindex=0, 1) value associated with a CORESET (control resource set) and CORESETs having the same poolindex are grouped. Thus, in this example, the BFD-RS set associated with CORESETpoolIndex=0 may be a primary BFD-RS set or may be considered a more important BFD-RS set.

Thus, TRPs or BFD-RS sets having a specific index may be prioritized or considered more important than other TRPs or BFD-RS sets, which may cause the UE to adjust scheduling restrictions, beam failure detection evaluation period and/or candidate beam evaluation period differently in the event of a failed primary BFD-RS set, as compared to how these parameters or operations may be adjusted in the case of a failed non-primary BFD-RS set. Thus, the adjusting of the scheduling restrictions and beam failure detection evaluation period may be applied to any non-failed BFD-RS sets, and the adjusting of the candidate beam evaluation period may be applied to the failed BFD-RS set, and different values for these parameters may be used or applied by the UE, depending on the beam failure status of the plurality (e.g., two) BFD-RS sets (e.g., based on whether the primary BFD-RS set has failed, whether the non-primary BFD-RS set has failed, or both have failed).

According to an example embodiment, it may be assumed that a single antenna panel (and thus a single receive beam) can be active for a UE at a given time and the BFD-RS in BFD-RS sets are not overlapped.

Also, in some embodiments, it may be assumed that one BFD-RS set (TRP) fails and there is no ‘primary’ BFD-RS set (associated with a primary/master TRP). Alternatively, there may be a BFD-RS set (TRP) (such as a primary or master BFD-RS set) that is more important than other BFD-RS sets (TRP(s)). In some examples, the primary or master or “first” BFD-RS set may be determined as the BFD-RS set with a specific index (e.g., BFD-RS set index=0, or other specific index). E.g., BFD-RS set with index 0 (or 1 or configurable by network or network node), may be considered more important. Various embodiments described herein consider when one or both BFD-RS sets fails (e.g., different beam failure status of BFD-RSs) and how it may impact UE requirements and/or how different beam failure status of BFD-RSs may cause the UE to perform different adjustments and/or use different values for scheduling restrictions, beam failure detection evaluation period and/or candidate beam evaluation period.

Some further embodiments A)-H) are described below.

A) In one embodiment, the candidate beam detection (CBD) time (candidate beam evaluation period) may depend on (or vary, or may be adjusted based on) whether UE has determined that beam failure has been detected on one or both (or all) BFD-RS set(s) configured for the UE, e.g., for the serving cell (e.g., based on the beam failure status of the BFD-RS sets):

In one example, if UE has determined that one but not all of the BFD-RS sets has failed, the UE assumes the scaling of the candidate beam evaluation period (Tevaluate_CBD) with a factor scaling_factor_mTRP>1. The scaling_factor_mTRP may have, e.g., values greater than 1, such as, e.g., 1.5, 2, . . . , in this case, which operates to provide an increased or larger candidate beam evaluation period.

In one example, if UE determines that both BFD-RS sets have failed, and/or candidate beam evaluation is requested/triggered for both BFD-RS sets (e.g., indicating that both BFS-RS sets have failed), UE assumes the scaling_factor_mTRP=1 (or no scaling for candidate beam evaluation period), since there are no links that are operating, and it is thus most urgent to re-establish at least one link for the UE. For example, when both BFD-RS sets fail, the UE is assumed to determine a candidate beam(s) for failed BFD-RS sets with no scaling is used for the candidate beam evaluation period or it applies the scaling scaling_factor_mTRP=1. Thus, for example, no scaling of beam candidate evaluation period is performed (thus the original unscaled, or shorter beam candidate evaluation period is used) in this case, since there is no need or no advantage in extending the deadline for beam candidate evaluation period, which might delay the UE completing the beam candidate evaluation and sending a report (e.g., a beam failure recovery report) indicating the selected beam candidate.

B) In one embodiment, example, if UE has initiated (or started) candidate beam evaluation (or candidate beam search) for the failed BFD-RS set (TRP) (i.e., UE has initiated beam evaluation for the failed BFD-RS set but not for the other/all BFD-RS sets) and the UE has applied a scaling factor (e.g. scaling_factor_mTRP>1) for the candidate beam evaluation of the candidate beam set associated with the failed BFD-RS set (failed TRP), and the following examples may be considered:

If the second BFD-RS set now fails (which means that both BFD-RS sets have now failed, at different time instances) and UE is evaluating candidate beams for at least one other BFD-RS set, the UE applies the scaling_factor_mTRP=1 for the candidate beam evaluation for the second TRP with the related failed BFD-RS set. In this case, no scaling or period increase is applied (or scaling=1 is applied) for candidate beam evaluation period of the failed BFD-RSs, since both beams (or both BFD-RS sets) have failed, and thus, it is important or urgent to re-establish the beams or BFD-RS sets as soon as possible (and also because there is not a non-failed BFD-RS for the UE to monitor a downlink control channel or detect beam failure).

In one option, if one of the BFD-RS set (and respective candidate beam set) has a higher priority than the other BFD-RS set, the scaling factor (e.g., scaling_factor_mTRP) may (or may always) be set to one (e.g., scaling_factor_mTRP=1, or no scaling for candidate beam evaluation period) for candidate beam evaluation period for the higher priority (e.g., primary) BFD-RS set. The priority of TRP (and thus, the priority of the BFD-RS set for this TRP) may be pre-configured by network through higher layer signaling or pre-determined (based on BFD-RS set index). Thus, if the first beam or first BFD-RS set that failed is a priority (or primary) BFD-RS set, then no scaling is performed for candidate beam evaluation period (no increase in candidate beam evaluation period for non-failed beam) for the first BFD-RS, since UE would like to quickly re-establish priority beam (priority BFD-RS set) for multi-TRP communication session.

C) In one embodiment, the scaling factor (e.g., scaling_factor_mTRP) for candidate beam evaluation period may depend on the RS configuration (SSB/CSI-RS) for candidate beam sets. If a cell is configured with one BFD-RS set, UE may apply a scaling_factor_mTRP=1 for the respective cell for the candidate beam evaluation period, for the failed BFD-RS set. If a cell is configured with two BFD-RS sets, UE may apply a scaling_factor_mTRP>1 (greater than 1) for the respective cell for the candidate beam evaluation period, for the failed BFD-RS set.

D) In one embodiment, the scaling factor (e.g., scaling_factor_mTRP) for candidate beam evaluation period and/or the candidate beam evaluation period and/or scheduling restrictions may be dependent on the failure (or not) of a specific one of the BFD-RS sets (e.g., such as the primary BFD-RS set). For example, as described herein, different adjustments (or different values) of candidate beam evaluation period and/or scheduling restrictions may be used or applied depending on the specific BFD-RS set that has failed, such as whether a higher priority or a primary BFD-RS set has failed. For example, a scaling factor=1 (e.g., scaling_factor_mTRP=1) may be used for beam evaluation period for the primary BFD-RS set (which is used by the UE to perform candidate beam evaluation when the primary BFD-RS set has failed), while a larger scaling factor (scaling_factor_mTRP>1) may be used for beam evaluation period (causing a longer beam evaluation period) for the non-primary BFD-RS set, where this longer candidate beam evaluation period is used by the UE to perform candidate beam evaluation when the non-primary BFD-RS set has failed). Also, for example, in the case where only the primary BFD-RS has failed, scheduling restrictions may be applied for the UE to monitor a downlink control channel of the non-primary BFD-RS (e.g., which may make resources available for the UE to spend more time performing candidate beam evaluation for the primary BFD-RS set). Similarly, in the case where only the non-primary BFD-RS has failed, scheduling restrictions are not (or may not be) applied for the UE to monitor a downlink control channel of the primary BFD-RS (since this is the priority/primary BFD-RS or link or primary TRP, and the UE should continue, as usual, to monitor the PDCCH of primary TRP for DCI and UCI, for example. Thus, some further examples may include:

In one example it may be considered that a specific BFD-RS set (and related candidate set) is the set with index 0 (zero). The set with index 0 may be considered as the “primary TRP” (primary BFD-RS set is better term for claims) and typically it is configured with common channels (configured with transmission of DCI which UE must monitor) for UE.

In one example, if UE has determined that one BFD-RS set has failed (with index 1, non-primary BFD-RS set), the UE is not allowed scheduling restrictions for the receptions or monitoring of the PDCCH/PDSCH or the transmission of PUCCH/PUSCH scheduled/associated with the CORESETs of non-failed BFD-RS set (index 0, which is considered primary BFD-RS). E.g. UE is required to monitor PDCCH of non-failed primary BFD-RS instead of prioritizing (in case of conflict) candidate beam evaluation for the failed non-primary BFD-RS set. Thus, in this example, no scheduling restrictions are applied to the non-failed primary BFD-RS set.

In one further example, the UE applies the scaling factor of scaling_factor_mTRP=x for the candidate beam evaluation for the failed set—x being a given scaling factor defined for the candidate beam set (or BFD-RS if CBD set is not configured). In this example, Index 1 (non-primary) BFD-RS has failed, so then UE may use a longer candidate beam evaluation period (e.g., scaling_factor_mTRP>1 for candidate beam evaluation period) for failed non-primary BFD-RS set (since the UE must continue to monitor or prioritize monitoring of PDCCH of primary/priority beam/BFD-RS). Also, when the failed BFD-RS set is associated with CORESETs of poolindex 1 (or e.g., non-primary BFD-RS set has failed), the UE assumes scheduling restrictions are not applied to transmissions on (e.g., DCI/PDCCH and scheduled PDSCH transmissions) CORESET(s) associated with non-failed primary BFD-RS set and applies scaling (increased period) for the candidate beam detection.

In one example, if UE has determined that the primary BFD-RS set has failed (e.g., with index 0), the UE is allowed scheduling restrictions for the receptions of the PDCCH/PDSCH or the transmission of PUCCH/PUSCH scheduled/associated with the CORESETs of non-failed non-primary BFD-RS set (index 1). Thus, the UE is not required to transmit or receive transmissions (e.g., not required to monitor PDCCH) associated with non-failed non-primary BFD-RS set (TRP/CORESETs) when the UE performs candidate beam evaluation for the failed primary BFD-RS set.

In one further example, it applies the scaling factor of scaling_factor_mTRP=1 (no scaling) for the candidate beam evaluation for the failed set. In this case, the candidate beam evaluation period is not scaled (not increased), because the primary beam/BFD-RS set has failed. Thus, in this case, a scaling factor=1 may be used for candidate beam evaluation period for failed primary BFD-RS, to cause the UE to quickly select a new beam for primary BFD-RS set.

In one further example, UE may apply the scaling factor of scaling_factor_BFD (beam failure detection)=x (x times scaling or scaling with factor of X>1) for the beam failure detection for the non failed BFD-RS set while UE evaluates candidate beams for the failed set.

In one further example, if the candidate beam detection reference signal of (or associated with) the failed BFD-RS set overlaps (in time) with the BFD-RS of other (non-failed) BFD-RS set, UE is assumed to prioritize candidate beam evaluation over BFD-RS of the non-failed BFD-RS set.

E) In one embodiment, if the candidate beam detection RS of failed BFD-RS set overlaps with the BFD-RS of the of the non-failed BFD-RS set, UE assumes no scaling (or scaling of 1) for the candidate beam evaluation period. Additionally or alternatively, it assumes scaling >1 for the beam failure detection evaluation period.

F) The scaling_factor_mTRP is the scaling factor used to modify the candidate beam evaluation period (where candidate beam evaluation is performed in response to beam failure detection) for at least one BFD-RS set or for both BFD-RS sets. For example, the scaling_factor_mTRP may be dependent on which of the BFD-RS sets the factor is applied. In one example there may be independent values applied for each of the BFD-RS sets and the associated candidate beam RS sets (thus causing different values to be used for candidate beam evaluation periods for different BFD-RS sets).

G) In one embodiment, the beam failure detection evaluation period (Tevaluate_BFD) with multiple BFD-RS sets (TRPs) are scaled with a factor scaling_factor_BFDx. the Scaling factor may depend on following aspects, for example: In one example, UE assumes scaling_factor_BFDx or scaling_factor_mTRP for both sets or UE assumes BFD-RS set/candidate beam RS set specific scaling factor. In one example embodiment, if number of BFD-RS (in total) to be included in the BFD-RS sets (k=0,1) does not exceed specific value e.g. 2, UE is assumed NOT to scale the beam failure detection or it shall use the scaling factor of scaling_factor_BFDx=1. In one example embodiment, if number of BFD-RS (in total) to be included in the BFD-RS sets (k=0,1) exceeds specific value e.g. 2, UE (is allowed to) scale the beam failure detection period by scaling factor of scaling_factor_BFDx>1. Wherein the scaling_factor_BFDx is the scaling factor used to modify the evaluation period for beam failure detection for at least one BFD-RS set or for both BFD-RS sets.

H) In additional/alternative embodiment, the scaling factor for beam failure detection (e.g., Tevaluate_CBD) may depend on the number of BFD-RS set(s) configured per each respective cell. If a cell is configured with one BFD-RS set, UE assumes scaling_factor_mTRP=1 for the respective cell for the candidate beam evaluation period. If a cell is configured with two BFD-RS sets, UE assumes scaling_factor_mTRP=x (where x is greater than 1) for the respective cell for the candidate beam evaluation period

In any of the examples herein, the scaling operator that may be applied and that may cause increase in the evaluation period or periods (such as beam failure detection evaluation or candidate beam evaluation or other evaluation) may be additive operator (e.g., additive operator such as + may be used and the period is increased by e.g., X milliseconds/seconds) or multiplication factor where the period is increased by a factor of X (e.g., x=2).

Various example embodiments describe BFD UE behaviors under multi-TRP (mTRP) deployments. A UE may conduct beam management from each TRP including monitoring signal quality under a given beamformed radio link. For this purpose, a UE may conduct beam signal quality evaluation by evaluating BFD-RS(s) associated with each CORESETPoolindex (or in other words, set of CORESETs assumed to be transmitted by one or more TRP(s)).

Multi-TRP scenarios have defined as intra-cell multi-TRP and inter-cell multi-TRP. Various examples or example embodiments described herein may be used to cover both of the scenarios. As illustrated in FIG. 2, beamformed radio link alignment between a TRP and a UE can be made or failed in multi-TRP deployment. The UE can receive PDCCH and PDSCH from a TRP when the beam alignment is confirmed. Then, the UE is supposed to monitor CORESET of the PDCCH from the TRP(s) for data communication.

Also, a UE can be configured with up to 2 BFD-RS sets per DL bandwidth part. Once a UE detects beam failure that the given beamformed radio link quality falls in beam failure declaration criteria, a UE declares beam failure when the gNB TX (transmit) and UE RX (receive) beams are mis-aligned physically or UE RX (receive) beams are out of gNB beam coverage. Then, the UE declares beam failure and performs the next actions to search for a new beam via beam candidate evaluation. Then, there are multiple options that a UE may take for failed TRP and also for the rest of TRPs that still provide good radio links (non-failed TRPs or BFD-RSs).

First, a multiple TRP configuration may be provided and a UE RX (receive) capability as, for example: Multiple TRP (mTRP) are configured for data communications in intra-cell or inter-cell; and, A UE is capable to receive a signal from one angle or arrival (AoA) direction, that implies the UE has only a single (active) RX antenna panel.

When multiple TRPs are configured, embodiments are described for beam failure detection and recovery among mTRPs as, e.g.: 1) A UE has determined that beam failure has been detected on one or more BFD-RS set(s) but not all BFD-RS sets configured for the UE; 2) A UE has determined that beam failure has been detected on all of BFD-RS sets configured for the UE; or 3) A UE has determined that beam failure has been detected on one or more BFD-RS set(s) that is/are prioritized (such as BFD-RS from a primary/master) TRP or primary BFD-RS set. These are examples of beam failure status of BFD-RS sets.

As noted, the UE may adjust, or may select or use different values for or associated with, one or more of the following based on the beam failure status of the BFD-RS sets: scheduling restrictions, a beam failure detection evaluation period, and/or a candidate beam evaluation period.

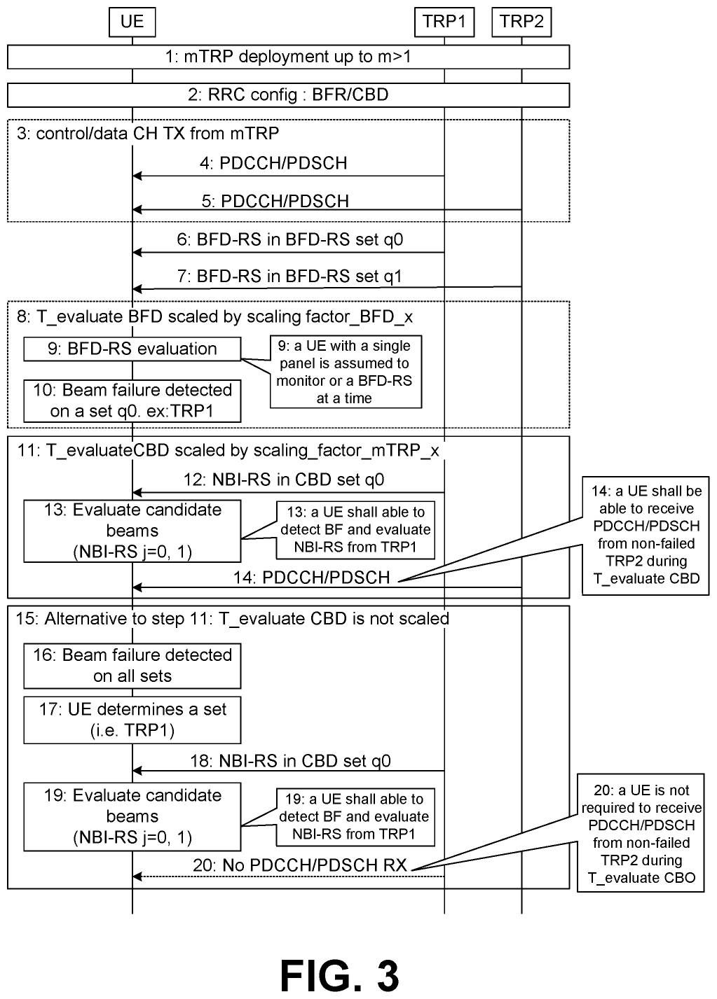

FIG. 3 is a diagram illustrating operation of beam failure recovery in a multi-TRP system according to an example embodiment. In FIG. 3, none of the TRPs are (necessarily) a primary TRP. Thus, the priority of the TRPs is not defined for FIG. 3. A UE may be in communication with TRP1 and TRP1. At operation 1, a TRP communication session is established between UE and TRP1 and TRP2. At operation 2, RRC configuration information is received by the UE. For example, at operation 2, the UE may receive configuration information related to beam failure recovery and candidate beam evaluation, such as a configuration (or identification of) a BFD-RS set and an associated candidate beam set. For example, BFD-RS set q0 may be configured for TRP1, and BFD-RS set q1 may be configured for TRP2. At operations 3-5, the UE may receive control signals and data from each of the TRPs, including receiving control information via PDCCH (physical downlink control channel) and/or data via PDSCH (physical downlink shared channel) from TRP1 (operation 4), and receive control information and/or data from TRP2 (operation 5). At operations 6-7, the UE receives beam failure detection reference signal (BFD-RS) set from each of the TRP1 (operation 6) and TRP2 (operation 7).

At operation 8 of FIG. 3, beam failure detection is performed, and the beam failure detection evaluation period (for the non-failed BFD-RS set q) is scaled (increased), based on the failure status of the two BFD-RS sets, e.g., since one of the BFD-RS sets has failed. This scaling or using an increased BFD evaluation period may allow the UE more time to spend on evaluating candidate beams associated with the failed BFD-RS.

At operation 9 of FIG. 3, beam failure detection is BFD-RS is performed (e.g., measuring RSRP of BFD-RS sets from TRP1 and TRP2 to determine if a beam failure has occurred). At step 10, the UE detects a beam failure on BFD-RS set q0 configured for TRP1. Scaling (increasing) of the candidate beam evaluation period may be performed for the failed BFD-RS set, or not, depending on the failure status of the BFD-RS sets (e.g., by using two different scaling factors, scaling_factor_mTRP=1 where no scaling is performed and scaling_factor_mTRP>1 where scaling is performed). Operations 11-14 are performed if the candidate beam evaluation period is scaled or increased, while operations 15-19 are performed if no scaling or increasing of the candidate beam evaluation period is performed.

At operation 12 of FIG. 3, the UE receives and measures candidate beams of the candidate beam set associated with the failed BDF-RS set q0 (e.g., NBI-RSs in candidate beam set associated with BFD-RS q0, for TRP1). Because beam failure detection has been scaled or increased at operations 8-10, the UE should be able to detect beam failure on non-failed BFD-RS set and perform candidate beam evaluation for TRP1. Also, because candidate beam evaluation period has been scaled or increased, at operation 14, the UE is able to monitor downlink channels, e.g., PDCCH and/or PDSCH of the non-failed BDF-RS set q1 configured for TRP2.

At operations 15-19, the candidate beam evaluation period to evaluate candidate beams associated with the failed BFD-RS set q0 is not scaled or increased. At operation 16, beam failure is now detected on all beams. At operation 17, UE determines or selects a BFD-RS set (e.g., BFD-RS set q0 configured for TRP1) to perform beam candidate evaluation. At operation 18, the UE receives and measures candidate beams of the candidate beam set associated with BFD-RS set q0. At operation 19, UE evaluates the candidate beams. Also at operation 19, because beam failure detection period was scaled or increased at operation 8, the UE can also perform beam failure detection and evaluate candidate beams associated with BFD-RS set q0 for TRP1. However, at operation 20, the UE is not required to monitor downlink channel(s), e.g., PDCCH and/or PDSCH from a non-failed TRP2 during candidate beam evaluation period.

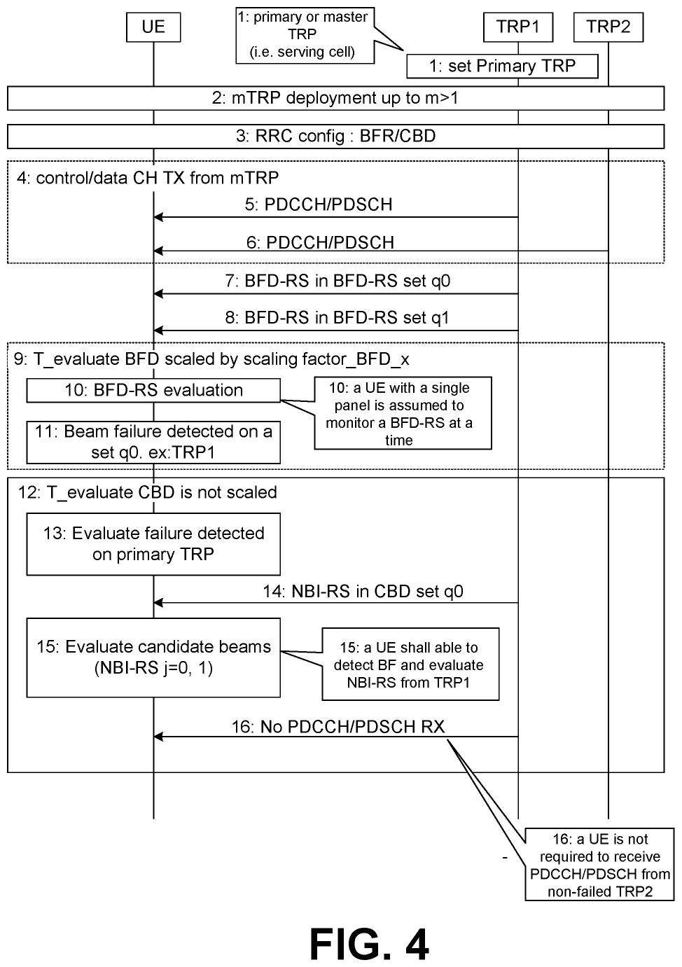

FIG. 4 is a diagram illustrating operation of beam failure recovery in a multi-TRP system that includes a primary (or master) TRP according to an example embodiment. At operation 1 of FIG. 4, TRP1 is set or configured as the primary (or master) TRP for the UE. Operations 2-8 are the same or similar to operations 1-7 of FIG. 3. Note, that at operation 9 of FIG. 4, because a beam failure has occurred on one of the BFD-RS sets, the beam failure detection evaluation period is scaled or increased for non-failed BFD-RS set q1. At operations 10-11, beam failure detection is performed or evaluated on BFD-RS set q0, and at operation 11, a beam failure is detected for BFD-RS set q0 (configured for TRP1, the primary TRP).

At operation 12 of FIG. 4, because the primary BFD-RS set q0 (configured for TRP1) has failed, the candidate beam evaluation period is not scaled or increased to evaluate candidate beams of the candidate beam set associated with the failed BFD-RS set (e.g., to require the UE to more quickly evaluate candidate beams for the failed BFD-RS set configured for the primary TRP1). At operation 13, the UE may perform beam failure detection and evaluate the failure detected on the BFD-RS set configured for primary TRP (TRP1). At operation 14, the UE may receive candidate beams of the candidate beam set associated with the failed BFD-RS set q0 configured for primary TRP1. At operation 15, the UE may evaluate (e.g., compare RSRP of measured beams/RSs to a threshold) candidate beams in order to select or determine a new candidate beam for the primary TRP1. Because the beam failure detection period for the non-failed BFD-RS set was scaled or increase at operation 9, the UE can perform both operations of detecting beam failure and performing candidate beam evaluation of candidate beams associated with failed BFD-RS set q0 and TRP1. However, at operation 16, in the event of a conflict, the UE is not required to monitor (e.g., receive and/or decode or demodulate) downlink channels of the non-failed BFD-RS set q1 configured for non-primary TRP2.

Some further examples will be described:

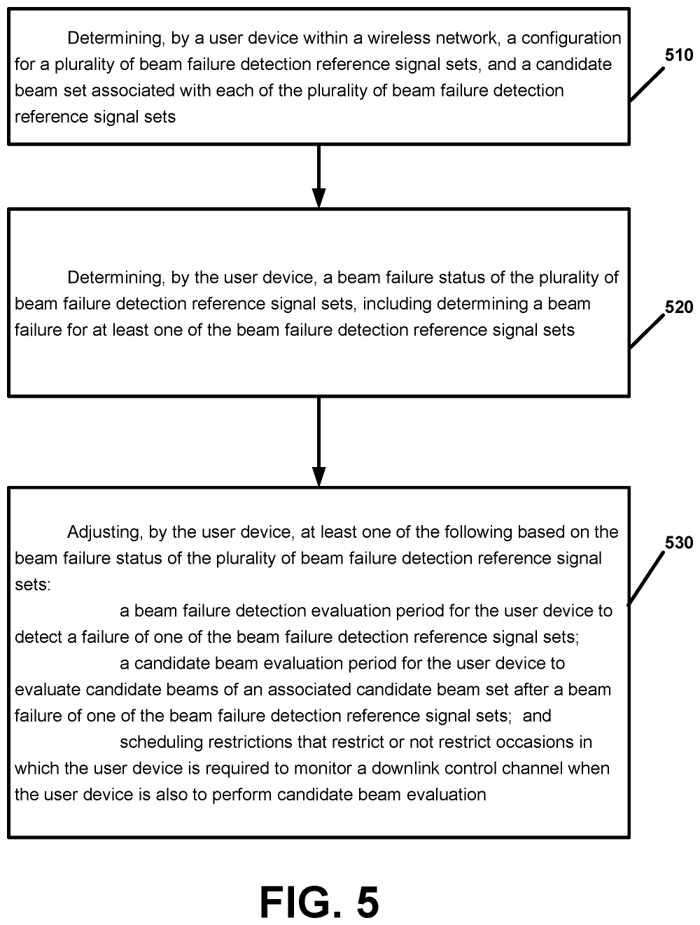

Example 1. FIG. 5 is a flow chart illustrating operation of a UE according to an example embodiment. Operation 510 includes determining, by a user device within a wireless network, a configuration for a plurality of beam failure detection reference signal sets, and a candidate beam set associated with each of the plurality of beam failure detection reference signal sets. Operation 520 includes determining, by the user device, a beam failure status of the plurality of beam failure detection reference signal sets, including determining a beam failure for at least one of the beam failure detection reference signal sets. Operation 530 includes adjusting, by the user device, at least one of the following based on the beam failure status of the plurality of beam failure detection reference signal sets: a beam failure detection evaluation period for the user device to detect a failure of one of the beam failure detection reference signal sets; a candidate beam evaluation period for the user device to evaluate candidate beams of an associated candidate beam set after a beam failure of one of the beam failure detection reference signal sets; and scheduling restrictions that restrict or not restrict occasions in which the user device is required to monitor a downlink control channel when the user device is also to perform candidate beam evaluation.

Example 2. The method of example 1 wherein: the plurality of beam failure detection reference signal sets comprises one or more beam failure detection-reference signals (BFD-RS); and a candidate beam set comprises one or more reference signals for new candidate beam evaluation and detection.

Example 3. The method of any of examples 1-2, wherein the beam failure status of at least one beam failure detection reference signal set of the plurality of beam failure detection reference signal sets may be determined based on a request to evaluate candidate beams in a candidate beam set associated with a beam failure detection reference signal set, wherein the request is received from another protocol layer of the user device.

Example 4. The method of example 3, wherein receiving, by the user device, a request to evaluate candidate beams in a candidate beam set associated with a beam failure detection beam reference signal set indicates a beam failure for the beam failure detection beam reference signal set.

Example 5. The method of any of examples 1-4, wherein: the adjusting a beam failure detection evaluation period comprises adjusting, based on the beam failure status of the plurality of beam failure detection reference signal sets, a first scaling factor for the beam failure detection evaluation period; and the adjusting a candidate beam evaluation period comprises adjusting, based on the beam failure status of the plurality of beam failure detection reference signal sets, a second scaling factor for the candidate beam evaluation period.

Example 6. The method of any of examples 1-5, wherein the adjusting scheduling restrictions comprises: adjusting of scheduling restrictions that, when applied for the user device, may restrict or not restrict occasions in which the user device is required to monitor a downlink control channel associated with a non-failed beam failure detection reference signal set in order for the user device to prioritize or adjust prioritization of, in case of a conflict with candidate beam evaluation, candidate beam evaluation to evaluate candidate beams associated with a failed beam failure detection reference signal set over monitoring a downlink control channel associated with a non-failed beam failure detection reference signal set.

Example 7. The method of example 6: wherein the plurality of beam failure detection reference signal sets comprise a first beam failure detection reference signal set and a second beam failure detection reference signal set; wherein scheduling restrictions are not used by the user device to monitor a downlink control channel associated with a non-failed first beam failure detection reference signal set based on a failed second beam failure detection reference signal set; and wherein scheduling restrictions are used by the user device to monitor a downlink control channel associated with for a non-failed second beam failure detection reference signal set based on a failed first beam failure detection reference signal set.

Example 8. The method of example 6: wherein the plurality of beam failure detection reference signal sets comprise a primary beam failure detection reference signal set and a non-primary beam failure detection reference signal set; wherein scheduling restrictions are not used by the user device to monitor a downlink control channel associated with a non-failed primary beam failure detection reference signal set based on a failed non-primary beam failure detection reference signal set; and wherein scheduling restrictions are used by the user device to monitor a downlink control channel associated with a non-failed non-primary beam failure detection reference signal set based on a failed primary beam failure detection reference signal set.

Example 9. The method of any of examples 1-8 wherein the beam failure status of the plurality of beam failure detection reference signal sets comprises one or more of the following: only one of the plurality of beam failure detection reference signal sets configured for the user device has failed; at least one of the plurality of beam failure detection reference signal sets, but fewer than all of the plurality of beam failure detection reference signal sets configured for the user device, has failed; all of the plurality of beam failure detection reference signal sets configured for the user device have failed; at least one primary beam failure detection reference signal set configured for the user device has failed, but a non-primary beam failure detection reference signal set configured for the user device has not failed; and a non-primary beam failure detection reference signal set configured for the user device has failed, but a primary beam failure detection reference signal set configured for the user device has not failed.

Example 10. The method of any of examples 1-9: wherein the plurality of beam failure detection reference signal sets comprise a first beam failure detection reference signal set and a second beam failure detection reference signal set; wherein a first candidate beam evaluation period is used to evaluate candidate beams of candidate beam sets associated with one or both of the first and second beam failure detection reference signal sets based on a beam failure of both of the first and second beam failure detection reference signal sets; and wherein a second candidate beam evaluation period, different than the first candidate beam evaluation period, is used by the user device to evaluate candidate beams of a candidate beam set associated with the first beam failure detection reference signal set based on a beam failure only of the first beam failure detection reference signal set.

Example 11. The method of example 10: wherein the first candidate beam evaluation period is obtained based on a first candidate beam evaluation period scaling factor; and wherein the second candidate beam evaluation period is obtained based on a second candidate beam evaluation period scaling factor that is different from the first candidate beam evaluation period scaling factor.

Example 12. The method of any of examples 10-11, wherein the first beam failure detection reference signal set comprises a primary beam failure detection reference signal set, and the second beam failure detection reference signal set comprises a non-primary beam failure detection set, wherein different candidate beam evaluation periods are configured or used by the user device for evaluating candidate beams associated with the primary beam failure detection reference signal set and the non-primary beam failure detection reference signal set.

Example 13. The method of any of examples 1-12: wherein the plurality of beam failure detection reference signal sets comprise a primary beam failure detection reference signal set and a non-primary beam failure detection reference signal set; wherein a first candidate beam evaluation period is used by the user device to evaluate candidate beams of a candidate beam set associated with the primary beam failure detection reference signal set based on a beam failure of the primary beam failure detection reference signal set and a failure of less than all of the plurality of beam failure detection reference signal sets; and wherein a second beam failure detection evaluation period, longer than the first beam failure detection evaluation period, is used by the user device to evaluate candidate beams of a candidate beam set associated with the non-primary beam failure detection reference signal set based on a beam failure of the non-primary beam failure detection reference signal set and a failure of less than all of the plurality of beam failure detection reference signal sets.

Example 14. The method of any of examples 1-13: wherein the plurality of beam failure detection reference signal sets comprise a first beam failure detection reference signal set and a second beam failure detection reference signal set; wherein a first beam failure detection evaluation period is used to evaluate candidate beams of candidate beam sets associated with one or both of the first and second beam failure detection reference signal sets after a beam failure of both of the first and second beam failure detection reference signal sets; wherein the first beam failure detection reference signal set has failed, and the second beam failure detection reference signal set has not failed, and the adjusting a beam failure detection evaluation period for the user device comprises: using, by the user device, a second beam failure detection evaluation period, longer than the first beam failure detection evaluation period, to evaluate candidate beams of a candidate beam set associated with the first beam failure detection reference signal set.

Example 15. The method of any of examples 1-14, wherein: the beam failure detection evaluation period is adjusted based on one or more of: a number of beams included within the plurality of beam failure detection reference signal sets; whether a number of beams included within the plurality of beam failure detection reference signal sets is greater than a threshold.

Example 16, The method of any of examples 1-15, wherein the primary beam failure detection reference signal set, the non-primary beam failure detection reference signal set, or a candidate beam set associated with the primary beam failure detection reference signal beam set or associated with the non-primary beam failure detection reference signal set, may be determined based on an index of the beam failure detection reference signal set or an index of a candidate beam set.

Example 17. An apparatus comprising means for performing the method of any of examples 1-16.

Example 18. A non-transitory computer-readable storage medium comprising instructions stored thereon that, when executed by at least one processor, are configured to cause a computing system to perform the method of any of examples 1-16.

Example 19. An apparatus comprising: at least one processor; and at least one memory including computer program code; the at least one memory and the computer program code configured to, with the at least one processor, cause the apparatus at least to perform the method of any of examples 1-16.

Example 20. An apparatus comprising: at least one processor; and at least one memory including computer program code; the at least one memory and the computer program code configured to, with the at least one processor, cause the apparatus at least to: determine, by a user device within a wireless network, a configuration for a plurality of beam failure detection reference signal sets, and a candidate beam set associated with each of the plurality of beam failure detection reference signal sets; determine, by the user device, a beam failure status of the plurality of beam failure detection reference signal sets, including determining a beam failure for at least one of the beam failure detection reference signal sets; and, adjust, by the user device, at least one of the following based on the beam failure status of the plurality of beam failure detection reference signal sets: a candidate beam evaluation period for the user device to evaluate candidate beams of an associated candidate beam set after a beam failure of one of the beam failure detection reference signal sets; a beam failure detection evaluation period for the user device to detect a failure of one of the beam failure detection reference signal sets; and scheduling restrictions that restrict or not restrict occasions in which the user device is required to monitor a downlink control channel.

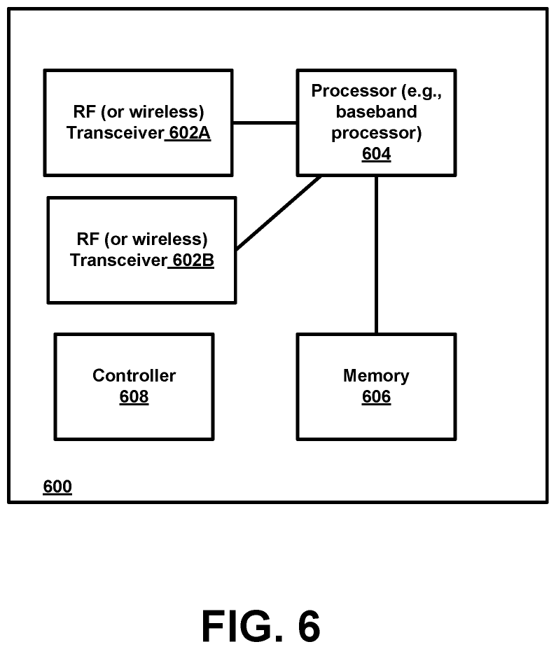

FIG. 6 is a block diagram of a wireless station or node (e.g., UE, user device, AP, BS, eNB, gNB, RAN node, network node, TRP, or other node) 600 according to an example embodiment. The wireless station 600 may include, for example, one or more (e.g., two as shown in FIG. 6) RF (radio frequency) or wireless transceivers 602A, 602B, where each wireless transceiver includes a transmitter to transmit signals and a receiver to receive signals. The wireless station also includes a processor or control unit/entity (controller) 604 to execute instructions or software and control transmission and receptions of signals, and a memory 606 to store data and/or instructions.

Processor 604 may also make decisions or determinations, generate frames, packets or messages for transmission, decode received frames or messages for further processing, and other tasks or functions described herein. Processor 604, which may be a baseband processor, for example, may generate messages, packets, frames or other signals for transmission via wireless transceiver 602 (602A or 602B). Processor 604 may control transmission of signals or messages over a wireless network, and may control the reception of signals or messages, etc., via a wireless network (e.g., after being down-converted by wireless transceiver 602, for example). Processor 604 may be programmable and capable of executing software or other instructions stored in memory or on other computer media to perform the various tasks and functions described above, such as one or more of the tasks or methods described above. Processor 604 may be (or may include), for example, hardware, programmable logic, a programmable processor that executes software or firmware, and/or any combination of these. Using other terminology, processor 604 and transceiver 602 together may be considered as a wireless transmitter/receiver system, for example.

In addition, referring to FIG. 6, a controller (or processor) 608 may execute software and instructions, and may provide overall control for the station 600, and may provide control for other systems not shown in FIG. 6, such as controlling input/output devices (e.g., display, keypad), and/or may execute software for one or more applications that may be provided on wireless station 600, such as, for example, an email program, audio/video applications, a word processor, a Voice over IP application, or other application or software.

In addition, a storage medium may be provided that includes stored instructions, which when executed by a controller or processor may result in the processor 604, or other controller or processor, performing one or more of the functions or tasks described above.

According to another example embodiment, RF or wireless transceiver(s) 602A/602B may receive signals or data and/or transmit or send signals or data. Processor 604 (and possibly transceivers 602A/602B) may control the RF or wireless transceiver 602A or 602B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-20. (canceled)

21. An apparatus comprising:
at least one processor; and
at least one memory including computer program code;
the at least one memory and the computer program code configured to, with the at least one processor, cause the apparatus at least to:
determine a configuration for a plurality of beam failure detection reference signal sets, and a candidate beam set associated with each of the plurality of beam failure detection reference signal sets;
determine a beam failure status of the plurality of beam failure detection reference signal sets, including determining a beam failure for at least one of the beam failure detection reference signal sets;
adjust at least one of the following based on the beam failure status of the plurality of beam failure detection reference signal sets:
a candidate beam evaluation period for the apparatus to evaluate candidate beams of an associated candidate beam set after a beam failure of one of the beam failure detection reference signal sets;
a beam failure detection evaluation period for the apparatus to detect a failure of one of the beam failure detection reference signal sets; and
scheduling restrictions that restrict or not restrict occasions in which the apparatus is required to monitor a downlink control channel.

22. The apparatus of claim 21, wherein:
the plurality of beam failure detection reference signal sets comprises one or more beam failure detection-reference signals; and
a candidate beam set comprises one or more reference signals for new candidate beam evaluation and detection.

23. The apparatus of claim 21, wherein the beam failure status of at least one beam failure detection reference signal set of the plurality of beam failure detection reference signal sets is determined based on a request to evaluate candidate beams in a candidate beam set associated with a beam failure detection reference signal set, wherein the request is received from another protocol layer of the apparatus.

24. The apparatus of claim 21, wherein receiving a request to evaluate candidate beams in a candidate beam set associated with a beam failure detection beam reference signal set indicates a beam failure for the beam failure detection beam reference signal set.

25. The apparatus of claim 21, wherein:
the adjusting a beam failure detection evaluation period comprises the at least one memory and the computer program code configured to, with the at least one processor, cause the apparatus at least to: adjust, based on the beam failure status of the plurality of beam failure detection reference signal sets, a first scaling factor for the beam failure detection evaluation period; and
the adjusting a candidate beam evaluation period comprises the at least one memory and the computer program code configured to, with the at least one processor, cause the apparatus at least to: adjust, based on the beam failure status of the plurality of beam failure detection reference signal sets, a second scaling factor for the candidate beam evaluation period.

26. The apparatus of claim 21, wherein the adjusting scheduling restrictions comprises the at least one memory and the computer program code configured to, with the at least one processor, cause the apparatus at least to:
adjust of scheduling restrictions that, when applied for the apparatus, restrict or not restrict occasions in which the apparatus is required to monitor a downlink control channel associated with a non-failed beam failure detection reference signal set in order for the apparatus to prioritize or adjust prioritization of, in case of a conflict with candidate beam evaluation, candidate beam evaluation to evaluate candidate beams associated with a failed beam failure detection reference signal set over monitoring a downlink control channel associated with a non-failed beam failure detection reference signal set.

27. The apparatus of claim 26:
wherein the plurality of beam failure detection reference signal sets comprise a first beam failure detection reference signal set and a second beam failure detection reference signal set;
wherein scheduling restrictions are not used by the apparatus to monitor a downlink control channel associated with a non-failed first beam failure detection reference signal set based on a failed second beam failure detection reference signal set; and
wherein scheduling restrictions are used by the apparatus to monitor a downlink control channel associated with for a non-failed second beam failure detection reference signal set based on a failed first beam failure detection reference signal set.

28. The apparatus of claim 26:
wherein the plurality of beam failure detection reference signal sets comprise a primary beam failure detection reference signal set and a non-primary beam failure detection reference signal set;
wherein scheduling restrictions are not used by the apparatus to monitor a downlink control channel associated with a non-failed primary beam failure detection reference signal set based on a failed non-primary beam failure detection reference signal set; and
wherein scheduling restrictions are used by the apparatus to monitor a downlink control channel associated with a non-failed non-primary beam failure detection reference signal set based on a failed primary beam failure detection reference signal set.

29. The apparatus of claim 21, wherein the beam failure status of the plurality of beam failure detection reference signal sets comprises one or more of the following:
only one of the plurality of beam failure detection reference signal sets configured for the apparatus has failed;
at least one of the plurality of beam failure detection reference signal sets, but fewer than all of the plurality of beam failure detection reference signal sets configured for the apparatus, has failed;
all of the plurality of beam failure detection reference signal sets configured for the apparatus have failed;
at least one primary beam failure detection reference signal set configured for the apparatus has failed, but a non-primary beam failure detection reference signal set configured for the apparatus has not failed; and
a non-primary beam failure detection reference signal set configured for the apparatus has failed, but a primary beam failure detection reference signal set configured for the apparatus has not failed.

30. The apparatus of claim 21:
wherein the plurality of beam failure detection reference signal sets comprise a first beam failure detection reference signal set and a second beam failure detection reference signal set;
wherein a first candidate beam evaluation period is used to evaluate candidate beams of candidate beam sets associated with one or both of the first and second beam failure detection reference signal sets based on a beam failure of both of the first and second beam failure detection reference signal sets; and
wherein a second candidate beam evaluation period, different than the first candidate beam evaluation period, is used by the apparatus to evaluate candidate beams of a candidate beam set associated with the first beam failure detection reference signal set based on a beam failure only of the first beam failure detection reference signal set.

31. The apparatus of claim 30:
wherein the first candidate beam evaluation period is obtained based on a first candidate beam evaluation period scaling factor; and
wherein the second candidate beam evaluation period is obtained based on a second candidate beam evaluation period scaling factor that is different from the first candidate beam evaluation period scaling factor.

32. The apparatus of claim 30, wherein the first beam failure detection reference signal set comprises a primary beam failure detection reference signal set, and the second beam failure detection reference signal set comprises a non-primary beam failure detection set, wherein different candidate beam evaluation periods are configured or used by the apparatus for evaluating candidate beams associated with the primary beam failure detection reference signal set and the non-primary beam failure detection reference signal set.

33. The apparatus of claim 21:
wherein the plurality of beam failure detection reference signal sets comprise a primary beam failure detection reference signal set and a non-primary beam failure detection reference signal set;
wherein a first candidate beam evaluation period is used by the apparatus to evaluate candidate beams of a candidate beam set associated with the primary beam failure detection reference signal set based on a beam failure of the primary beam failure detection reference signal set and a failure of less than all of the plurality of beam failure detection reference signal sets; and
wherein a second beam failure detection evaluation period, longer than the first beam failure detection evaluation period, is used by the apparatus to evaluate candidate beams of a candidate beam set associated with the non-primary beam failure detection reference signal set based on a beam failure of the non-primary beam failure detection reference signal set and a failure of less than all of the plurality of beam failure detection reference signal sets.

34. The apparatus of claim 21:
wherein the plurality of beam failure detection reference signal sets comprise a first beam failure detection reference signal set and a second beam failure detection reference signal set;
wherein a first beam failure detection evaluation period is used to evaluate candidate beams of candidate beam sets associated with one or both of the first and second beam failure detection reference signal sets after a beam failure of both of the first and second beam failure detection reference signal sets;
wherein the first beam failure detection reference signal set has failed, and the second beam failure detection reference signal set has not failed, and the adjusting a beam failure detection evaluation period for the apparatus comprises:
using a second beam failure detection evaluation period, longer than the first beam failure detection evaluation period, to evaluate candidate beams of a candidate beam set associated with the first beam failure detection reference signal set.

35. The apparatus of claim 21, wherein:
the beam failure detection evaluation period is adjusted based on one or more of:
a number of beams included within the plurality of beam failure detection reference signal sets;
whether a number of beams included within the plurality of beam failure detection reference signal sets is greater than a threshold.

36. The apparatus of claim 35, wherein the primary beam failure detection reference signal set, the non-primary beam failure detection reference signal set, or a candidate beam set associated with the primary beam failure detection reference signal set or associated with the non-primary beam failure detection reference signal set, is determined based on an index of the beam failure detection reference signal set or an index of a candidate beam set.

37. A method comprising:
determining, by a user device within a wireless network, a configuration for a plurality of beam failure detection reference signal sets, and a candidate beam set associated with each of the plurality of beam failure detection reference signal sets;
determining, by the user device, a beam failure status of the plurality of beam failure detection reference signal sets, including determining a beam failure for at least one of the beam failure detection reference signal sets; and
adjusting, by the user device, at least one of the following based on the beam failure status of the plurality of beam failure detection reference signal sets:
a beam failure detection evaluation period for the user device to detect a failure of one of the beam failure detection reference signal sets;
a candidate beam evaluation period for the user device to evaluate candidate beams of an associated candidate beam set after a beam failure of one of the beam failure detection reference signal sets; and
scheduling restrictions that restrict or not restrict occasions in which the user device is required to monitor a downlink control channel.

38. The method of claim 37 wherein:
the plurality of beam failure detection reference signal sets comprises one or more beam failure detection-reference signals; and
a candidate beam set comprises one or more reference signals for new candidate beam evaluation and detection.

39. The method of claim 37, wherein the beam failure status of at least one beam failure detection reference signal set of the plurality of beam failure detection reference signal sets is determined based on a request to evaluate candidate beams in a candidate beam set associated with a beam failure detection reference signal set, wherein the request is received from another protocol layer of the user device.

40. A non-transitory computer-readable storage medium comprising instructions stored thereon that, when executed by at least one processor, are configured to cause a computing system to perform:
determining a configuration for a plurality of beam failure detection reference signal sets, and a candidate beam set associated with each of the plurality of beam failure detection reference signal sets;
determining a beam failure status of the plurality of beam failure detection reference signal sets, including determining a beam failure for at least one of the beam failure detection reference signal sets; and
adjusting at least one of the following based on the beam failure status of the plurality of beam failure detection reference signal sets:
a beam failure detection evaluation period for a user device to detect a failure of one of the beam failure detection reference signal sets;
a candidate beam evaluation period for the user device to evaluate candidate beams of an associated candidate beam set after a beam failure of one of the beam failure detection reference signal sets; and
scheduling restrictions that restrict or not restrict occasions in which the user device is required to monitor a downlink control channel.
